(19) United States
(12) Patent Application Publication
(10) Pub. No.: US 2021/0219524 A1
(43) Pub. Date: Jul. 22, 2021

(54) Animal training device and control method

(71) Applicant: Dogtra co., Ltd., Incheon (KR)

(72) Inventor: Min Kyun SO, Seoul (KR)

(21) Appl. No.: 17/150,314

(22) Filed: Jan. 15, 2021

(30) Foreign Application Priority Data
Jan. 17, 2020 (KR) 10-2020-0006498
Jan. 17, 2020 (KR) 10-2020-0006499

(51) Int. Cl. A01K 15/02; G01H 17/00; G10L 25/51; H04R 1/08

(52) U.S. Cl. CPC A01K 15/022; H04R 1/08; G10L 25/51; G01H 17/00

(57) ABSTRACT

Animal training device and control method provided. Animal training device includes a bark recognition sensor configured for recognizing a barking of an animal wearing the device on, a stimulus generator configured for generating a stimulus having a predetermined property according to a control signal, a controller configured for outputting the control signal when the barking is out of a preset range, wherein the controller receives a user input through the bark recognition sensor and changes the property of the stimulus in response to the user input.

### CROSS-REFERENCE TO RELATED APPLICATIONS

This patent application claims priority to Korean Patent Application No. 10-2020-0006498 and 10-2020-0006499 filed on Jan. 17, 2020, the entire disclosure of which is incorporated herein by reference.

### FIELD OF INVENTION

The present invention relates to animal training device and method of controlling.

### RELATED ART

Animal training devices have been developed and used as a means for is correcting the behavior of animals (for example, dogs). For example, a technology has been developed to suppress a dog barking by applying stimulus (electric stimulus or vibrations) to a dog in a collar-type device mounted on the dog's neck when a dog barking is detected by a sensor. Alternative techniques have been also developed in which a user (a trainer, a dog owner, etc.) operates a remote controller to send a command to a collar-type device mounted on a dog's neck to apply stimulus to a dog when the dog barks, goes out of the designated area, or attacks a human.

By using these animal training devices, it is possible to correct the behavior of the animal and to learn the desired behavior.

Aforementioned technologies are intended to help a reader understand the background of the present invention, and should not be regarded as acknowledgement that they are already well known to those who skilled in this field of technology.

### SUMMARY

The present invention is intended to provide animal training device of applying adjustable stimulus such as vibration and recognizing a user's setting command by use of a bark recognition sensor that can sense barking of an animal being trained and control method.

The present invention is intended to provide animal training device of recognizing barking sound of animal being trained and manually or automatically adjusting input sensing range to suit characteristics of animal being trained by use of a bark recognition sensor and control method.

Objects other than the present invention will be easily understood through the following description.

According to one aspect of the present invention, there is provided an animal training device, including a bark recognition sensor configured for recognizing a barking of an animal wearing the device on, a stimulus generator configured for generating a stimulus having a predetermined property according to a control signal, a controller configured for outputting the control signal when the barking is out of a preset range, wherein the controller receives a user input through the bark recognition sensor and changes the property of the stimulus in response to the user input.

In embodiment, the bark recognition sensor may include at least one of a microphone and a vibration sensor.

In embodiment, the data from the bark recognition sensor is recognized as the user input when at least one of length, interval and number of the data is within a predetermined range, wherein the controller is configured for changing an intensity level of stimulus.

In embodiment, the controller is configured for accumulating bark data input through the bark recognition sensor for an initial period of time, managing accumulated data as a reference data, and setting two or more input sensing ranges corresponding to the reference data.

In embodiment, if the animal wearing the device on is a dog, a first level of sensitivity in a range of 1,200 and 3,000 Hz is set to a small-sized dog, a second level of sensitivity in a range of 800 and 1,200 Hz is set to a middle-sized dog, and a third level of sensitivity in a range of 400 and 800 Hz is set to a large-sized dog.

In embodiment, the controller is configured for adjusting a filtering weight to the input sensing range according to a status of the animal wearing the device on.

In embodiment, when a body weight of the animal and a frequency are set as X axis and Y axis, a filtering weight curve is a graph in which the frequency of the filtering weight gradually decreases as the body weight increases, wherein the frequency of the filtering weight curve sharply changes in a boundary region where the sensitivity level changes.

In embodiment, the controller is configured for inputting normally without being filtered by applying the weighted value to a relatively loud sound when the bark recognition sensor recognizes a plurality of sounds in combination.

In embodiment, the sound that is inputted to the bark recognition sensor is normally inputted without being filtered when a posture of the animal wearing the device on is determined as a barking posture.

In embodiment, the sound that is inputted to the bark recognition sensor is normally inputted without being filtered when a sound and a vibration are inputted together to the bark recognition sensor.

According to another aspect of the present invention, there is provided a method of controlling an animal training device, including recognizing, by a barking recognition sensor, a barking of an animal wearing the device on, outputting, by a controller, a control signal for generating a stimulus when the barking is out of a preset range, and generating, by a stimulus generator, the stimulus having a predetermined property according to the control signal, wherein receiving a user input through the barking recognition sensor and changing by the controller the property of the stimulus according to the user input are preceded.

In embodiment, the method may further include accumulating bark data input through the bark recognition sensor for an initial period of time, managing accumulated data as a reference data, and setting two or more input sensing ranges corresponding to the reference data.

Other aspects, features, and advantages will be more apparent from accompanying drawings, claims and detailed description.

According to embodiment of the present invention, it is advantageous that recognition of user's setting command and adjustment of level of stimulus can be performed by use of a bark recognition sensor that can sense barking of an animal being trained.

In addition, it is advantageous that recognition of barking sound of animal being trained and manually or automatically adjusting input sensing range to suit characteristics of animal being trained can be performed by use of a bark recognition sensor.

### BRIEF DESCRIPTION OF ACCOMPANYING DRAWINGS

FIG. 1 is a perspective view of animal training device according to one embodiment of the present invention;

FIG. 2 is a block diagram of animal training device according to one embodiment of the present invention;

FIG. 3 is a flowchart showing method of adjusting stimulus intensity and method of adjusting input sensing range that are performed on animal training device according to one embodiment of the present invention;

FIG. 4 illustrates setting of stimulus level;

FIG. 5 illustrates adjusting input sensing range;

FIG. 6 illustrates a weight graph; and

FIG. 7 illustrates handling exceptions.

### DETAILED DESCRIPTION

The invention can be modified in various forms and specific embodiments will be described and shown below. However, the embodiments are not intended to limit the invention, but it should be understood that the invention includes all the modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these element should not be limited due to these terms. These terms will be used to distinguish one element from another element.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. If it is determined that detailed description of known techniques involved in the invention makes the gist of the invention obscure, the detailed description thereof will not be made.

Terms such as ˜part, ˜unit, ˜module mean an element configured for performing a function or an operation. This can be implemented in hardware, software or combination thereof.

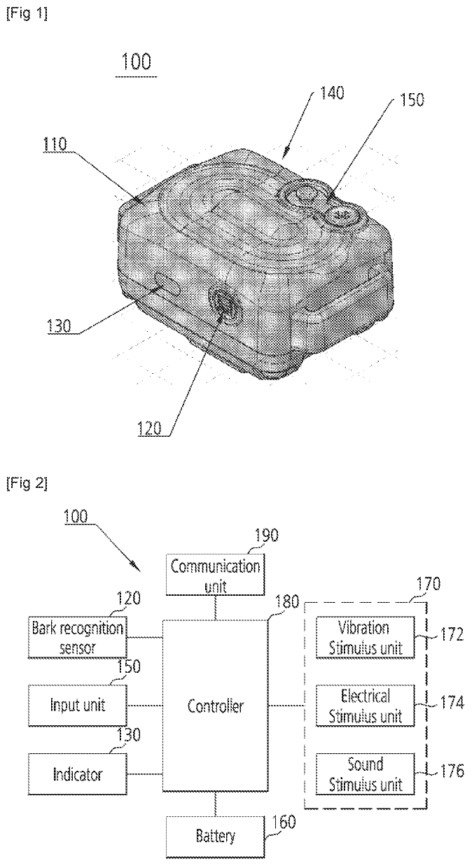

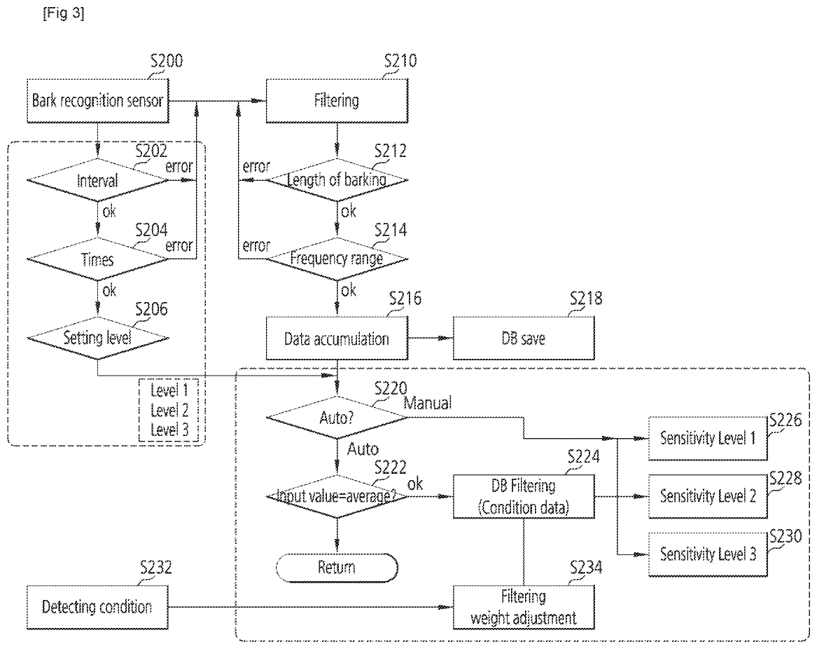

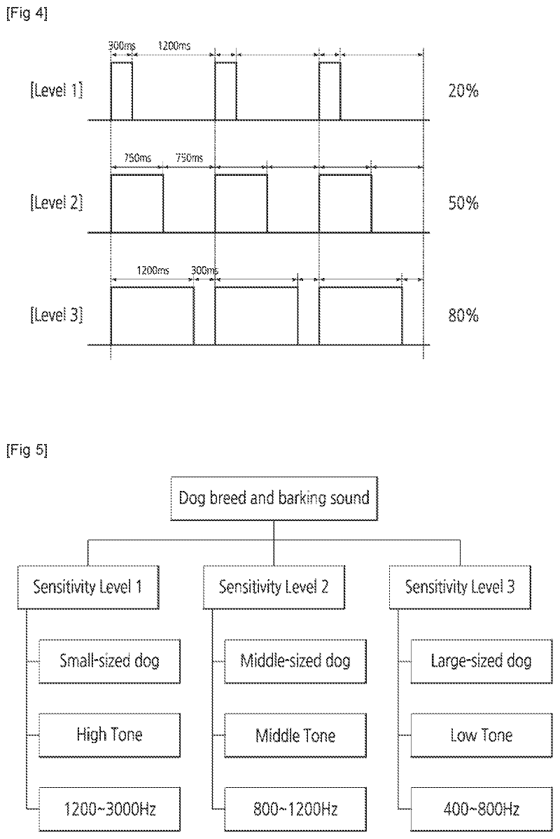

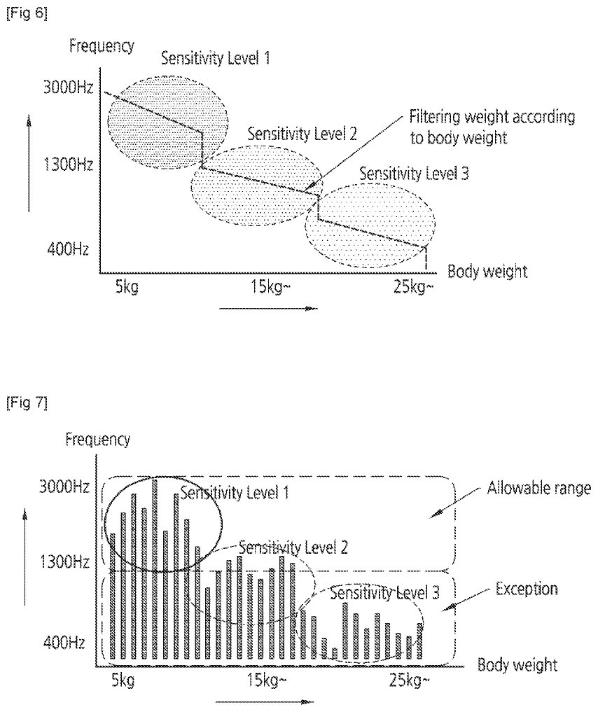

FIG. 1 is a perspective view of animal training device according to one embodiment of the present invention, FIG. 2 is a block diagram of animal training device according to one embodiment of the present invention, FIG. 3 is a flowchart showing method of adjusting stimulus intensity and method of adjusting input sensing range that are performed on animal training device according to one embodiment of the present invention, FIG. 4 illustrates setting of stimulus level, FIG. 5 illustrates adjusting input sensing range, FIG. 6 illustrates a weight graph, and FIG. 7 illustrates handling exceptions.

The animal training device 100 according to one embodiment of the present invention is a collar-type device that can be worn on the neck of an animal being trained by a fastening portion including a strap.

Referring to FIG. 1, the animal training device 100 according to the one embodiment may include a body 110 having a shape that can be worn on the neck of an animal to be trained by fastening a fastening portion as a basic skeleton.

The body 110 is a housing having an internal accommodation space, and an input unit 150, an indicator 130, a bark recognition sensor 120, and the like may be installed on an outer surface of the body 110. In addition, a controller 180, a communication unit 190, and a battery 160 may be mounted therein.

Referring to FIG. 2, the animal training device 100 may include the bark recognition sensor 120, the indicator 130, the controller 180, a stimulus generator 170, and the battery 160. Additionally, the input unit 150 and the communication unit 190 may be further included.

The animal training device 100 according to one embodiment is equipped with the stimulus generator 170 for generating a predetermined stimulus inside the body 110, and in case that a predetermined condition is satisfied as a result of the determination by the controller 180, it can generate the predetermined stimulus to correct the behavior of an animal being trained or to train the animal being trained.

The body 110 is provided with the barking recognition sensor 120, so that barking of the animal being trained that is wearing the device can be recognized and sensed. The bark recognition sensor 120 may include at least one of a microphone that senses a barking sound and a vibration sensor that senses a vibration (movement of neck muscle) generated when barking.

In addition, the input unit 150 for receiving a user command may be installed on the body 110. The input unit 150 may be, for example, a button and/or a switch. The device can be turned on/off by pressing a button (or switch). In addition, the stimulus properties (type, intensity, duration, etc.) may be determined by the number of presses of the button (or switch) or pressing button or by the time pressed.

In one embodiment, the bark recognition sensor 120 may function as an input receiving unit that receives a user input instead of the input unit 150 described above. When a user touches (or taps) the bark recognition sensor 120, the bark recognition sensor 120 may sense a sound or a vibration corresponding to the user's touch. The controller 180 may determine a stimulus property (for example, type, intensity, duration, etc.) according to touch properties such as touch length, touch interval, and number of touches.

In addition, the indicator 130 is installed on the body 110 to display an operation status of the device. The indicator 130 may be, for example, an LED. For example, when not in operation, the LED is turned off, and in normal operation, it emits green. In addition, in case of a low battery or an operation error, light is emitted in red, so that the user can check a device status through the indicator 130.

In addition, a battery 160 for supplying power to operate each component of the animal training device 100 may be mounted in the body 110. The battery 160 may be a disposable battery. Alternatively, the battery 160 may be a rechargeable battery that can be repeatedly used through charging. In the case of the rechargeable battery, a charging port 140 for charging may be provided in the body 110. It is connected to a charging terminal of a separate charging device through the charging port 140 to receive power for operation of the device, and may allow the battery 160 to be charged.

The stimulus generator 170 may be configured for generating the predetermined stimulus to correct the behavior of the animal being trained or to train the animal being trained according to the control of the controller 180 that determines the barking of the animal wearing the device on.

The stimulus generator 170 may include one or more of a vibration stimulus unit 172, an electrical stimulus unit 174, and a sound stimulus unit 176.

The vibration stimulus unit 172 includes a vibration motor that generates vibration stimulus corresponding to a control signal. According to the control signal, one or more vibration properties among pattern, intensity, and duration of vibration may be adjusted. Since the animal training device 100 is in close contact with the skin of the animal being trained, the vibration may stimulate a sense of touch of the animal being trained by generating the vibration.

The electrical stimulus unit 174 includes an electrode for generating an electrical stimulus corresponding to the control signal. The electrode is installed on the outer surface of the body 110 so as to be in close contact with the skin of the animal being trained, and can apply an electric shock having one or more of adjusted properties (for example, a pattern, an intensity, a duration, and so on) to the animal being trained.

The sound stimulus unit 176 includes a speaker that generates a sound stimulus corresponding to the control signal. One or more of sound properties such as a frequency, a pattern, an intensity, and a duration may be adjusted according to the control signal.

The sound stimulus unit 176 may generate a sound according to the audible frequency of the animal to be trained. By selecting a frequency range outside the human audible frequency, the user or the people around him cannot hear the sound, but the animal to be trained can hear. Therefore, effective animal training can be performed without damaging people around them.

The properties of the stimulus generated by the stimulus generator 170 may be adjusted by a control method (especially, a stimulus control method) to be described later.

The controller 180 is configured for controlling each component of the animal training device 100 to perform a predetermined function.

The controller 180 is configured for setting one or more of properties of the stimulus to be generated according to a user input. In addition, when the bark recognition sensor 120 recognizes the barking of the animal being trained, the control signal for generating the stimulus having a preset properties is output to the stimulus generator 170, thereby correcting or training the behavior of the animal being trained.

Alternatively, the controller 180 may receive the user input through the bark recognition sensor 120.

For this, a preset can be used to indicate that the sound or vibration input to the bark recognition sensor 120 is the user input. Alternatively, when the sound or vibration recognized through the bark recognition sensor 120 is compared with the barking of the animal being trained, it can be interpreted as the user input if a correlation is lower than the threshold value. Alternatively, since the sound or vibration recognized through the bark recognition sensor 120 may be one of the barking of the animal being trained or the user input, these can be compared to each of reference data and interpreted as the barking or the user input according to a result of relatively high similarity.

The user input (touch or tap) through the bark recognition sensor 120 may be a user command for setting level of stimulus intensity. It is possible to determine the level of stimulus intensity (for example, level 1 to level N) by detecting the data property of user inputs (touch length, tough interval, number of touches, etc).

For example, when the stimulus is vibration, the level of vibration may be set using Pulse Width Modulation (PWM). The intensity of vibration can be adjusted by adjusting the high pulse time to operate the vibration motor.

Referring to FIG. 4, a case in which the intensity is set to 20% for level 1, 50% for level 2, and 80% for level 3 is illustrated. Assuming that one cycle of the motor is 1500 ms. In level 1, by repeated control signal for applying high pulse only for 300 ms corresponding to 20% of one cycle and for not applying for 1200 ms corresponding to the remaining 80%, the stimulus equivalent to 20% of an overall intensity can be generated and applied to the animal. In level 2, by applying high pulse only for 750 ms corresponding to 50% of one cycle and not applying for 750 ms corresponding to the remaining 50%, the stimulus equivalent to 50% of the overall intensity can be generated and applied to the animal. In level 3, by applying high pulse only for 1200 ms corresponding to 80% of one cycle and not applying for 300 ms corresponding to the remaining 20%, the stimulus equivalent to 80% of the overall intensity can be generated and applied to the animal.

According to as a result of analysis of the user input, if the data property (at least one of the interval and the number of touches) of the user input through the bark recognition sensor 120 is out of a predetermined range, it may be determined as an input error and may not lead to setting level of stimulus intensity.

In addition, the controller 180 identifies the animal being trained that is wearing the animal training device 100 and enables accurate training. To this end, an input range of barking can be limited to suit the characteristics of the animal being trained, and input outside the range can be filtered to prevent false stimuli from occurring.

The barking attributes, such as the length and frequency range of data about the barking of the animal being trained recognized through the bark recognition sensor 120 may be collected and accumulated, and stored in a database, and converted into big data. In addition, through processing of big data, customized input filtering may be performed by reflecting characteristics that can be differentiated from other animals of the same breed that the animal being trained has.

For example, when the animal being trained is a dog, the filtering range may be divided into three stages as illustrated in FIG. 5 according to the breed and the sound tendency of barking.

In the case of small-sized dogs, due to their small size (low body weight), they have high tone and a characteristic of a high frequency band (1200˜3000 Hz), and in this case, the sensitivity can be set as level 1.

In the case of middle-sized dogs, they have a middle tone between small-sized dogs and large-sized dogs, and have characteristics in a middle frequency band (800˜1200 Hz), and the sensitivity can be set as level 2.

In the case of large-sized dogs, due to their large body (high body weight), they have a low tone and a low frequency band (400 to 800 Hz), and the sensitivity can be set as level 3.

The setting of the filtering range according to the size and the sound tendency of the dog is automatically performed through data analysis, or the user can select it in the manual mode.

Referring back to FIG. 2, the animal training device 100 may further include a communication unit 190 for transmitting and receiving various data and information by wirelessly communicating with a user terminal or server located remotely.

When various set values input by the user through the user terminal are received through the communication unit 190, the controller 180 can perform stimulus control, input sensing range control, and No Bark control according to the set values.

Alternatively, the communication unit 190 can receive data related to calibration for various sensors and/or new firmware for the controller 180 provided by the server, and the controller 180 can take appropriate measures such as sensor calibration and/or firmware update.

Hereinafter, a control method such as a method of adjusting stimulus using a bark recognition sensor and a method of automatically setting an input sensing range for barking sound will be described with reference to FIG. 3.

First, the method of adjusting a stimulus will be described.

As described above, the bark recognition sensor 120 may recognize the is barking of the animal, but depending on the situation, it can also be a means of receiving the user input in a new way rather than an existing button or switch.

When there is data sensed through the bark recognition sensor 120 (step S200), it is determined whether the data property of the sensed data (at least one of the length, the interval and number of touches) is within a preset range (steps S202 and S204, in FIG. 3 the embodiment which the touch interval and the number of touches are selected as the data properties is illustrated). When the data property is within the preset range, it can be regarded that the user input has been received through the bark recognition sensor 120. In this case, the level of stimulus intensity may be set according to the data property of the input data (step S206). According to this, when the input unit 150 is omitted or only turn-on/turn-off is possible, the bark recognition sensor 120, which is an essential component for animal training, can be used to enable the user input. Through this, the components of the animal training device 100 can be omitted or simplified, thereby reducing the manufacturing cost.

When the stimulus control is completed, the method of setting input sensing range may be performed.

The barking sound input by the animal being trained that is wearing the animal training device 100 is sensed for an initial period of time (step S210). The data length and the frequency range of the sensed barking sound are analyzed, and it is determined whether they are within the reference range (steps S212 and S214). The reference range is a range standardly set according to the type of animal, and may be an input range as illustrated in FIG. 5.

If the data length or the frequency range is out of the reference range, it can be treated as an error. If they are within the reference range, the sensed barking sound data is accumulated and processed as data related to the corresponding animal being trained (hereinafter ‘relation data’) (step S216).

Then, it is stored and managed in a database (step S218). The relation data stored and managed in the database and an average value of the accumulated and processed relation data is calculated and managed in the database. The relation data is based on a standard data, but may be data in which some attributes have been changed to suit the animal being trained that is currently wearing the animal training device 100. Accordingly, even if animals are similar size of the same breed, it is possible to reflect the properties of the barking sound changed according to the living environment, habit, and training level.

After the data accumulation is performed for a certain period of time, the input sensing range may be set by using the average value of the accumulated relation data to fit the animal being trained.

Then, in the input filtering process, the controller 180 checks the mode set (step S220).

When set to manual mode, the user may determine the input sensing range in one of the steps S226, S228, and S230 according to the breed and/or the barking tendency.

When set to automatic mode, the average value calculated by the above-described data accumulation process is compared with the newly inputted input value (step S222).

If the comparison result is determined to be the same within the margin of error, the filtering is performed according to the status information (step S224). For example, the level of sensitivity may be determined in one of level 1 (S226), level 2 (S228), and level 3 (S230) according to the filtering result.

When filtering is performed in step S224, the condition of the animal being trained is sensed (step S232), and the filtering weight may be adjusted based on the detected condition (step S234).

Animal condition detection may be performed using various sensors included in the animal training device 100 or using a separate sensing device.

For example, in the case of reflecting a body weight of the animal being trained, when the body weight information measured by a weight measuring device is received through the communication unit 190 or input through the input unit 150, as shown in FIG. 6, it can be reflected as filtering weight.

The filtering weight curve in conjunction with the body weight shows a frequency range in which the body weight gives a high filtering weight. For example, for a small-sized dog with 5 kg of body weight, a higher filtering weight may be given for a high frequency dose to 3000 Hz, and a large-sized dog with 25 kg of body weight may be given a higher filtering weight for a low frequency dose to 400 Hz.

With the body weight and frequency on the X-axis and Y-axis respectively, the filtering weight curve may be a graph in which the frequency gradually decreases as the body weight increases. In addition, the frequency of the filtering weight curve sharply changes in a boundary region where the sensitivity level changes.

In this way, after the input sensing range is set by the controller 180, the animal training device 100 may treat an input value as an exception when it falls within other range.

Referring to FIG. 7, a case in which the input sensing range is set to level 1 of sensitivity is illustrated. In this case, the range of 1300 to 3000 Hz, which corresponds to level 1 of sensitivity, becomes an allowable range that is recognized as the barking sound generated by the animal being trained, but the remaining range is treated as an exception as a sound not generated by the animal being trained.

The setting of the input sensing range is to filter out a barking sound made by an animal other than the animal being trained.

As another example, data accumulation in step S216 may be performed by reflecting the loudness of the dog's sound, or filtering weight may be adjusted in step S234. In the case of the animal wearing the animal training device 100, the animal is the closest animal to the animal training device 100, and its sound has a relatively louder than that of other animals around it. Accordingly, when sounds of various loudness are recognized in combination, the filtering weight is reflected for a relatively loud sound (dB), so that the sound is normally input without being filtered. Conversely, for relatively small sounds, since the filtering weights are not reflected, they can be filtered out. Through this, it is possible to effectively remove the sound generated by other animals located remotely.

As another example, when the bark recognition sensor 120 detects vibration as well as the barking sound, data accumulation may be performed in step S216 or the filtering weight may be adjusted in step S234. When the animal being trained that is wearing the animal training device 100 barks, vibration may be detected by the movement of the throat. Therefore, when the barking sound is recognized and vibration is also detected, it is determined as the barking sound generated by the animal being trained and accumulated as normal data. In addition, when there is a barking sound, the controller 180 may cause the barking prevention control to be performed by generating a stimulus.

As another example, when the animal being trained is wearing a harness capable of detecting a posture by use of a gyro sensor, a motion sensor, etc., the controller 180 may determine the current posture of the animal being trained through communication with the harness. There is a difference in posture when the animal being trained takes an action such as walking/running and when it takes a barking posture for barking. Therefore when it is identified as the barking posture and a barking sound is input through the barking recognition sensor 120, it will be possible to determine it as the sound of the corresponding animal being trained and accumulate it as normal data.

In addition, when there is a barking sound, the barking prevention control may be performed by generating a stimulus.

According to embodiments, it is possible to automatically set the input sensing range for the barking sound, and thus the criteria for determining the bark sound that covers the existing wide range can be subdivided to suit the bark propensity to increase the accuracy of the bark recognition. Through this, it is possible to treat the barking sound generated by surrounding animals other than the animal wearing the device as external sound.

In addition, by analyzing and accumulating bark data, it is possible to automatically set an input sensing range suitable for the animal wearing the device on.

The above-described method of adjusting stimulus and method of setting input sensing range may be implemented in the form of a recording medium including computer-executable instructions such as an application or a program module, executed by a computer. Computer-readable medium can be any available medium that can be accessed by a computer, and includes both volatile and nonvolatile medium, removable and non-removable medium. Further, the computer-readable medium may include a computer storage medium. Computer storage medium includes both volatile and nonvolatile, removable and non-removable medium implemented in any method or technology for storage of information such as computer readable instructions, data structures, program modules or other data.

The above-described method of adjusting stimulus and method of setting input sensing range may be executed by a built-in application in the terminal (this may include a program included in a platform or operating system basically installed on the terminal), and may be executed by an application (i.e., a program) directly installed on the master terminal through an application store server, an application providing server such as a web server related to the application or service. In this sense, the above-described method of adjusting stimulus and method of setting input sensing range can be implemented as a built-in application (i.e., program) or an application installed by the user, and can be recorded on a computer-readable medium.

While the invention has been described above with reference to exemplary embodiments, it will be understood by those skilled in the art that the invention can be modified and changed in various forms without departing from the concept and scope of the invention described in the appended claims.

What is claimed is:

1. An animal training device, comprising:
a bark recognition sensor configured for recognizing a barking of an animal wearing the device on;
a stimulus generator configured for generating a stimulus having a predetermined property according to a control signal;
a controller configured for outputting the control signal when the barking is out of a preset range,
wherein the controller receives a user input through the bark recognition sensor and changes the property of the stimulus in response to the user input.

2. The animal training device of claim 1, wherein the bark recognition sensor comprises at least one of a microphone and a vibration sensor.

3. The animal training device of claim 2, wherein the data from the bark recognition sensor is recognized as the user input when at least one of length, interval and number of the data is within a predetermined range,
wherein the controller is configured for changing an intensity level of stimulus.

4. The animal training device of claim 1, wherein the controller is configured for accumulating bark data input through the bark recognition sensor for an initial period of time, managing accumulated data as a reference data, and setting two or more input sensing ranges corresponding to the reference data.

5. The animal training device of claim 1, wherein if the animal wearing the device on is a dog, a first level of sensitivity in a range of 1,200 and 3,000 Hz is set to a small-sized dog, a second level of sensitivity in a range of 800 and 1,200 Hz is set to a middle-sized dog, and a third level of sensitivity in a range of 400 and 800 Hz is set to a large-sized dog.

6. The animal training device of claim 4, wherein the controller is configured for adjusting a filtering weight to the input sensing range according to a status of the animal wearing the device on.

7. The animal training device of claim 6, wherein when a body weight of the animal and a frequency are set as X axis and Y axis, a filtering weight curve is a graph in which the frequency of the filtering weight gradually decreases as the body weight increases, wherein the frequency of the filtering weight curve sharply changes in a boundary region where the sensitivity level changes.

8. The animal training device of claim 6, wherein the controller is configured for inputting normally without being filtered by applying the weighted value to a relatively loud sound when the bark recognition sensor recognizes a plurality of sounds in combination.

9. The animal training device of claim 6, wherein the sound that is inputted to the bark recognition sensor is normally inputted without being filtered when a posture of the animal wearing the device on is determined as a barking posture.

10. The animal training device of claim 6, wherein the sound that is inputted to the bark recognition sensor is normally inputted without being filtered when a sound and a vibration are inputted together to the bark recognition sensor.

11. A method of controlling an animal training device, comprising:
recognizing, by a barking recognition sensor, a barking of an animal wearing the device on;
outputting, by a controller, a control signal for generating a stimulus when the barking is out of a preset range; and
generating, by a stimulus generator, the stimulus having a predetermined property according to the control signal,
wherein receiving a user input through the barking recognition sensor and changing by the controller the property of the stimulus according to the user input are preceded.

12. The method of controlling an animal training device of claim 11 further comprising:
accumulating bark data input through the bark recognition sensor for an initial period of time, managing accumulated data as a reference data; and
setting two or more input sensing ranges corresponding to the reference data.
